(19) United States
(12) Patent Application Publication
(10) Pub. No.: US 2023/0089744 A1
(43) Pub. Date: Mar. 23, 2023

(54) ANTENNA ASSEMBLY AND WIRELESS ACCESS DEVICE

(71) Applicant: HUAWEI TECHNOLOGIES CO., LTD., Shenzhen (CN)

(72) Inventors: Xinghui Ji, Suzhou (CN); Bo Yuan, Suzhou (CN); Ziliang Yan, Shenzhen (CN)

(73) Assignee: HUAWEI TECHNOLOGIES CO., LTD., Shenzhen (CN)

(21) Appl. No.: 18/052,578

(22) Filed: Nov. 4, 2022

Related U.S. Application Data
(63) Continuation of application No. PCT/CN2020/119730, filed on Sep. 30, 2020.

(30) Foreign Application Priority Data
May 22, 2020 (CN) 202010444447.3

(51) Int. Cl. H01Q 1/52; H01Q 1/50; H01Q 1/48; H01Q 1/22; H01Q 21/00; H01Q 1/36

(52) U.S. Cl. CPC H01Q 1/521; H01Q 1/50; H01Q 1/48; H01Q 1/22; H01Q 21/00; H01Q 1/36

(57) ABSTRACT

An antenna assembly and a wireless access device are provided. The antenna assembly includes a first antenna part and a second antenna part. A first port, a first radiation arm, a first ground point, and a first bearing part of a bearing plate form the first antenna part. A second port, a second radiation arm, a second ground point, and a second bearing part of the bearing plate form the second antenna part. The first radiation arm is configured to radiate a radio frequency signal received by the first port, and transmit a received radio frequency signal to the first port. The second radiation arm is configured to radiate a radio frequency signal received by the second port, and transmit a received radio frequency signal to the second port. An anti-interference path passing through the bearing plate exists between the first port and the second port.

### CROSS-REFERENCE TO RELATED APPLICATIONS

This application is a continuation of International Application No. PCT/CN2020/119730, filed on Sep. 30, 2020, which claims priority to Chinese Patent Application No. 202010444447.3, filed on May 22, 2020. The disclosures of the aforementioned applications are hereby incorporated by reference in their entireties.

### TECHNICAL FIELD

Embodiments of this application relate to the field of antenna technologies, and in particular, to an antenna assembly and a wireless access device.

### BACKGROUND

A wireless access point (AP) is an access point of a wireless network, and is commonly referred to as a “hot spot”. A wireless device (for example, a mobile phone, a mobile device, or a laptop computer) may establish a connection to the wireless access point, so that the wireless access point can provide a wireless network for the wireless device. In addition, the wireless access point may establish a wireless connection to another AP, to expand a coverage area of the wireless network.

A multiple-input multiple-output (MIMO) technology can greatly increase a data throughput and a transmit distance of a system without increasing a bandwidth or a total transmit power expenditure. A core concept of MIMO is to effectively improve spectral efficiency of a wireless communications system by using a spatial degree of freedom provided by a plurality of transmit antennas and a plurality of receive antennas, so as to increase a transmission rate and improve communication quality. An existing AP device generally uses a MIMO antenna. With an upgrade of the AP device, a size of the AP device becomes smaller. In addition, with development of communications technologies, more communication frequency bands may be used for wireless communication, so that a quantity of links (or referred to as a quantity of streams) that the AP device can provide is also increasing. Therefore, a quantity of MIMO antennas on a mainboard of the AP device needs to be increased to ensure that the AP device can provide more streams. It may be understood that the MIMO antennas need to be independent of each other to utilize performance of the MIMO antennas, that is, an interval between the MIMO antennas needs to be greater than a preset threshold, so that the MIMO antennas can meet an isolation requirement, and the performance of the MIMO antennas can be utilized.

In addition, in a current AP device, a radio frequency chipset is generally disposed on a mainboard. As a quantity of streams in the AP device increases, a quantity of radio frequency chipsets also increases, so that an area occupied by the radio frequency chipsets also increases. Moreover, because the radio frequency chipsets in the AP device are centrally disposed on the mainboard, space left for another part, for example, an antenna, becomes smaller. Furthermore, when a size of the AP device becomes smaller, for a MIMO antenna in the AP device, space on the mainboard becomes smaller. It is more difficult to design the MIMO antenna.

### SUMMARY

This application provides an antenna assembly and a wireless access device. Antennas may be disposed together to form the antenna assembly, and an isolation requirement is reduced by disposing parts of the antenna assembly without affecting performance of the antenna, so as to help miniaturize the wireless access device or deploy more antennas.

To achieve the foregoing technical objective, this application uses the following technical solutions.

According to a first aspect, this application provides an antenna assembly. The antenna assembly may include a first antenna part and a second antenna part. A first port, a first radiation arm corresponding to the first port, a first ground point corresponding to the first port, and a first bearing part of a bearing plate form the first antenna part. A second port, a second radiation arm corresponding to the second port, a second ground point corresponding to the second port, and a second bearing part of the bearing plate form the second antenna part.

The first antenna part may receive or radiate a radio frequency signal. When the first port in the antenna assembly receives the radio frequency signal, the first radiation arm may be configured to radiate the radio frequency signal received by the first port. When receiving the radio frequency signal, the first radiation arm may transmit the received radio frequency signal to the first port.

The second antenna part may receive or radiate the radio frequency signal. When the second port in the antenna assembly receives the radio frequency signal, the second radiation arm may be configured to radiate the radio frequency signal received by the second port. When receiving the radio frequency signal, the second radiation arm may transmit the received radio frequency signal to the second port.

An anti-interference path is formed between the first port in the first antenna part and the second port in the second antenna part by using the bearing plate, and the anti-interference path is configured to cancel interference caused by coupling between the first radiation arm and the second radiation arm.

The anti-interference path may be formed between the first port and the second port by using the bearing plate. Therefore, the first port may transmit the received radio frequency signal to the second port through the anti-interference path. Alternatively, the second port may transmit the received radio frequency signal to the first port through the anti-interference path. In this way, signal interference caused by coupling between the first radiation arm and the second radiation arm can be canceled. For example, when the first radiation arm radiates a radio frequency signal, if the second radiation arm receives the radio frequency signal radiated by the first radiation arm, interference is caused to the second antenna part, and performance of the second antenna part is affected. Alternatively, when the second radiation arm radiates a radio frequency signal, if the first radiation arm receives the radio frequency signal radiated by the second radiation arm, interference is caused to the first antenna part, and performance of the first antenna part is affected.

The first antenna part and the second antenna part are disposed together to form the antenna assembly, and interference caused by low isolation between antennas is canceled through the anti-interference path, so that performance of the antenna is not affected in a case of the low isolation. This helps miniaturize a wireless access device or deploy more antennas.

In an embodiment of the first aspect, the first radiation arm is disposed on a first side of the bearing plate, a part of the first radiation arm is connected to the bearing plate, and a first antenna gap exists between the first radiation arm and the bearing plate. The first port is disposed on a second side of the bearing plate, and the first ground point is disposed on a third side of the bearing plate. The second radiation arm is disposed on the third side of the bearing plate, a part of the second radiation arm is connected to the bearing plate, and a second antenna gap exists between the second radiation arm and the bearing plate. The second port is disposed on a fourth side of the bearing plate, and the second ground point is disposed on the first side of the bearing plate.

Both the first radiation arm and the second radiation arm are configured to radiate a radio frequency signal. The first antenna gap exists between the first radiation arm and the bearing plate, and the second antenna gap exists between the second radiation arm and the bearing plate. This helps the first radiation arm and the second radiation arm radiate or receive the radio frequency signal.

In another embodiment of the first aspect, the first antenna part may further include a third radiation arm corresponding to the first port, and the third radiation arm is disposed on the second side of the bearing plate. The second antenna part may further include a fourth radiation arm corresponding to the second port, and the fourth radiation arm is disposed on a fourth side of the bearing plate. The first radiation arm and the second radiation arm may be configured to radiate a low-frequency radio frequency signal, and the third radiation arm and the fourth radiation arm may be configured to radiate a high-frequency radio frequency signal.

It may be understood that the first port corresponding to the third radiation arm. In other words, the first port may receive two radio frequency signals, so that both the first radiation arm and the third radiation arm that are corresponding to the first port can radiate the radio frequency signals. Similarly, the second port may receive two radio frequency signals, so that both the second radiation arm and the fourth radiation arm that are corresponding to the second port can radiate the radio frequency signals. In this way, the antenna assembly can provide more links.

In another embodiment of the first aspect, the first bearing part and the second bearing part are integrally formed to form the bearing plate, or the first bearing part and the second bearing part are connected by using a connection part to form the bearing plate.

The first port, the first radiation arm, the third radiation arm, and the first ground point are disposed on the first bearing part, and the second port, the second radiation arm, the fourth radiation arm, and the second ground point are disposed on the second bearing part.

In another embodiment of the first aspect, the first radiation arm is disposed on an end, close to the first port, of the bearing plate, and the third radiation arm is disposed on an end, away from the first radiation arm, of the bearing plate. The second radiation arm is disposed on an end, close to the second port, of the bearing plate, and the fourth radiation arm is disposed on an end, close to the second radiation arm, of the bearing plate.

In another embodiment of the first aspect, a sum of a length of the first radiation arm and a width of the first antenna gap is ¼ of a wavelength of an electromagnetic wave corresponding to a first resonant frequency, and the first radiation arm is configured to receive or radiate a radio frequency signal having the first resonant frequency. A length of the third radiation arm is ¼ of a wavelength of an electromagnetic wave corresponding to a second resonant frequency, and the third radiation arm is configured to receive or radiate a radio frequency signal having the second resonant frequency.

The sum of the length of the first radiation arm and the width of the first antenna gap is related to a frequency band of the electromagnetic wave radiated by the first radiation arm. Therefore, the frequency band of the electromagnetic wave radiated by the first radiation arm may be adjusted by adjusting the length of the first radiation arm and the width of the first antenna gap. A frequency band of the electromagnetic wave radiated by the third radiation arm may be adjusted by adjusting the length of the third radiation arm.

In another embodiment of the first aspect, a sum of a length of the second radiation arm and a width of the second antenna gap is ¼ of the wavelength of the electromagnetic wave corresponding to the first resonant frequency, and the second radiation arm is configured to receive or radiate the radio frequency signal having the first resonant frequency. A length of the fourth radiation arm is ¼ of the wavelength of the electromagnetic wave corresponding to the second resonant frequency, and the fourth radiation arm is configured to receive or radiate the radio frequency signal having the second resonant frequency.

The sum of the length of the second radiation arm and the width of the second antenna gap is related to the frequency band of the electromagnetic wave radiated by the first radiation arm. Therefore, the frequency band of the electromagnetic wave radiated by the first radiation arm may be adjusted by adjusting the length of the second radiation arm and the width of the second antenna gap. A frequency band of the electromagnetic wave radiated by the fourth radiation arm may be adjusted by adjusting the length of the fourth radiation arm.

In another embodiment of the first aspect, a top, away from the second side, of the first radiation arm is of an arc-shaped structure, and the top, away from the second side, of the first radiation arm faces the first side. In other words, an endpoint position of the first radiation arm is of the arc-shaped structure, and the arc faces the first side.

In another embodiment of the first aspect, a top, away from the second side, of the second radiation arm is of an arc-shaped structure, and the top, away from the second side, of the second radiation arm faces the third side. In other words, an endpoint position of the second radiation arm is of the arc-shaped structure, and the arc faces the third side.

In another embodiment of the first aspect, the bearing plate is a conductor part. The conductor part includes a metal part or a metal plating part.

In another embodiment of the first aspect, the antenna assembly may further include a first support part and a second support part. The first support part is disposed at a position of the first antenna gap, and is configured to support the first radiation arm and the bearing plate. The second support part is disposed at a position of the second antenna gap, and is configured to support the second radiation arm and the bearing plate.

According to a second aspect, this application further provides a wireless access device. The wireless access device may include at least one antenna assembly in the first aspect and any embodiment of the first aspect, at least two radio frequency chipsets, and a mainboard. A radio frequency output end of each radio frequency chipset is connected to the first port and the second port in the antenna assembly, and a feed ground end on the mainboard is connected to the first ground point and the second ground point in the antenna assembly.

In an embodiment of the second aspect, the antenna assembly fits the mainboard, and the antenna assembly is located at a position close to an edge of the mainboard.

In another embodiment of the second aspect, the radio frequency chipset includes a first radio frequency chipset and a second radio frequency chipset. The first radio frequency chipset is disposed on a first surface of the mainboard, and the second radio frequency chipset is disposed on a second surface of the mainboard.

The first radio frequency chipset and the second radio frequency chipset are separately disposed on two sides of the mainboard. This may effectively save an area of the mainboard and helps miniaturize the wireless access device.

In another embodiment of the second aspect, the wireless access device further includes a matching circuit. An input end of the matching circuit is connected to the output end of the radio frequency chip set, and an output end of the matching circuit is connected to the first port or the second port. The matching circuit is configured to adjust a radio frequency signal received by the first port or the second port.

In another embodiment of the second aspect, the wireless access device may include a first antenna assembly and a second antenna assembly. A value of a distance between the first antenna assembly and the second antenna assembly is greater than a preset distance value.

### BRIEF DESCRIPTION OF DRAWINGS

FIG. 1 is a diagram of a three-dimensional structure of an antenna assembly according to an embodiment of this application;

FIG. 2 is a top view of a structure of an antenna assembly according to an embodiment of this application;

FIG. 3 is a top view of a structure of an antenna assembly including a support part according to an embodiment of this application;

FIG. 4 is a structural diagram of another antenna assembly according to an embodiment of this application;

FIG. 5 shows a standing wave ratio of an antenna assembly according to an embodiment of this application;

FIG. 6 shows isolation between a first antenna part and a second antenna part in an antenna assembly according to an embodiment of this application; and

FIG. 7 is a diagram of a hardware structure of a wireless access device according to an embodiment of this application.

### DESCRIPTION OF EMBODIMENTS

The following terms “first” and “second” are merely intended for a purpose of description, and shall not be understood as an indication or implication of relative importance or implicit indication of a quantity of indicated technical features. Therefore, a feature limited by “first” or “second” may explicitly or implicitly include one or more features. In the descriptions of the embodiments, unless otherwise stated, “a plurality of” means two or more than two.

The following explains terms in the embodiments of this application.

Coupling is a phenomenon that input and output of two or more than two circuit elements or electrical networks closely cooperate with each other and affect each other, and energy is transmitted from one side to another side through interaction. For example, an electromagnetic wave is transmitted from one radiation arm to another radiation arm.

Antenna polarization is a direction of electric field strength generated when an antenna radiates an electromagnetic wave. When the direction of the electric field strength is perpendicular to the ground, the wave is called a vertical polarization wave. When the direction of the electric field strength is parallel to the ground, the wave is called a horizontal polarization wave.

A polarization direction is a direction of an electric field of a polarized electromagnetic wave. An antenna polarization direction is a direction of an electric field generated when an antenna radiates an electromagnetic wave. The electromagnetic wave includes an electric field and a magnetic field, and a direction of the electric field of the electromagnetic wave when an antenna radiates the electromagnetic wave is the antenna polarization direction.

Generally, a radio frequency chipset is disposed on a mainboard of a current AP device. The radio frequency chipset includes a baseband, a radio frequency transceiver, and the like. An output end of the radio frequency chipset is connected to a radio frequency input end of an antenna, and the output end of the radio frequency chipset transmits a radio frequency signal to the radio frequency input end of the antenna, to radiate the radio frequency signal through the antenna. The solution using the radio frequency chipset improves an integration level of the AP device. As a quantity of links (or referred to as a quantity of streams) that the AP device can provide increases, a quantity of radio frequency chipsets also increases, and an area occupied by the radio frequency chipsets also increases. Because the radio frequency chipset is connected to the antenna, the quantity of radio frequency chipsets in the AP device increases, and a quantity of antennas also adaptively increases, so that the AP device can provide more links.

In one case, MIMO antennas are used in the AP device to radiate a radio frequency signal. It may be understood that, when the MIMO antennas are used, it needs to be ensured that radio frequency signals radiated by the MIMO antennas do not interfere with each other, so as to utilize performance of the MIMO antennas. The MIMO antennas are generally arranged on the mainboard of the AP device in a scattered manner. A spatial distance between the MIMO antennas is used to ensure isolation between the MIMO antennas, so as to ensure that the radio frequency signals radiated by the MIMO antennas do not interfere with each other. However, a manner of improving isolation by using the spatial distance between the MIMO antennas causes that the antennas in the AP device occupy relatively large space. Consequently, a size of the AP device is relatively large, and this is not conducive to miniaturizing the AP device.

In another case, a dual-polarized antenna is used in the AP device to radiate a radio frequency signal. It may be understood that an antenna structure of the dual-polarized antenna is an antenna combining radiators in two orthogonal directions: +45° and −45°. The structure enables the dual-polarized antenna to both receive a signal and transmit a signal. The dual-polarized antenna can reduce a value of a distance between two antenna radiators in the AP device, to reduce, to some extent, the size of the AP device. However, it is relatively difficult to design a dual-polarized antenna, and the two antenna radiators in the structure of the dual-polarized antenna are orthogonal. Consequently, the antenna occupies relatively large space in the AP device, and the size of the AP device is also relatively large.

An embodiment of this application provides an antenna assembly. The antenna assembly may include a first antenna part and a second antenna part, and the two antenna parts are disposed on a bearing plate. The two antenna parts can work independently. In this way, the antenna assembly may receive a plurality of input radio frequency signals, and may work in respective frequency bands, so that the antenna assembly can provide a plurality of links.

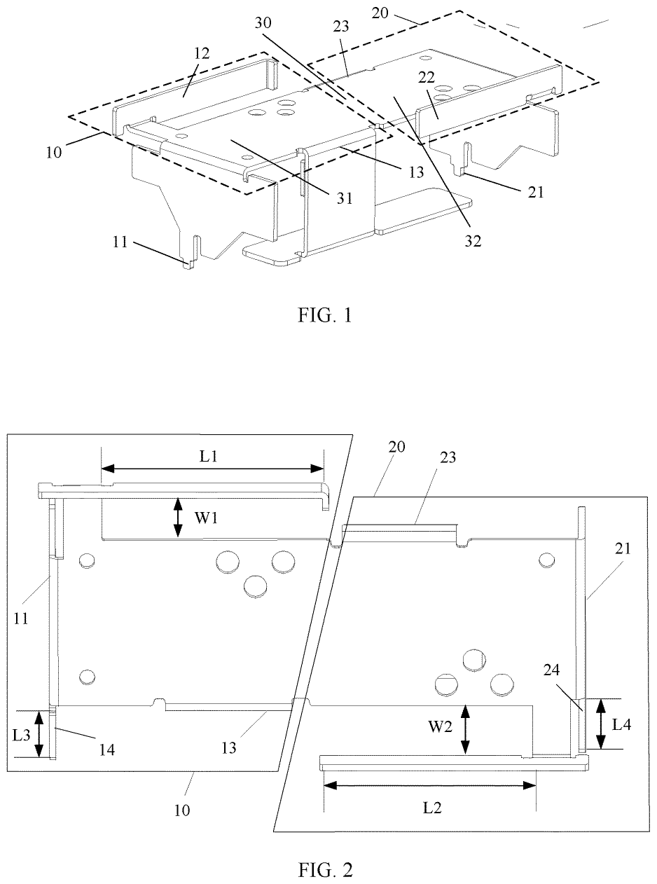

FIG. 1 is a structural diagram of an antenna assembly according to an embodiment of this application. As shown in FIG. 1, the antenna assembly includes a first antenna part 10 and a second antenna part 20. The first antenna part 10 includes a first port 11, and a first radiation arm 12 and a first ground point 13 that are corresponding to the first port 11. The second antenna part 20 includes a second port 21, and a second radiation arm 22 and a second ground point 23 that are corresponding to the second port 21. Both the first antenna part 10 and the second antenna part 20 are disposed on a bearing plate 30. The first antenna part 10 is disposed on a first bearing part 31, and the second antenna part 20 is disposed on a second bearing part 32.

The first radiation arm 12 is disposed on a first side of the bearing plate 30, a part of the first radiation arm 12 is connected to the bearing plate 30, and a first antenna gap exists between the first radiation arm 12 and the bearing plate 30. The first port 11 is disposed on a second side of the bearing plate 30, and the first ground point 13 is disposed on a third side of the bearing plate 30. The second radiation arm 22 is disposed on the third side of the bearing plate 30, a part of the second radiation arm 22 is connected to the bearing plate 30, and a second antenna gap exists between the second radiation arm 22 and the bearing plate 30. The second port 21 is disposed on a fourth side of the bearing plate 30, and the second ground point 23 is disposed on the first side of the bearing plate 30. The first side is opposite to the third side, and the second side is opposite to the fourth side.

In some implementations, the first radiation arm 12 in the first antenna part 10 is coupled to the second radiation arm 22 in the second antenna part 20. In other words, when the first radiation arm 12 radiates a radio frequency signal, the second radiation arm 22 may receive the radio frequency signal radiated by the first radiation arm 12. Alternatively, when the second radiation arm 22 radiates a radio frequency signal, the first radiation arm 12 may receive the radio frequency signal radiated by the second radiation arm 22. The first port 11 in the first antenna part 10 and the second port 21 in the second antenna part 20 form an anti-interference path. In other words, when the first port 11 receives a radio frequency signal, the radio frequency signal received by the first port 11 may be transmitted to the second port 21. Alternatively, when the second port 21 receives a radio frequency signal, the radio frequency signal received by the second port 21 may be transmitted to the first port 11. When the first port 11 receives a radio frequency signal, the first radiation arm 12 may be configured to radiate the radio frequency signal received by the first port 11. When the first radiation arm 12 radiates the radio frequency signal, the second radiation arm 22 may receive the radio frequency signal radiated by the first radiation arm 12, so that the radio frequency signal radiated by the first radiation arm 12 causes interference to the second antenna part 20. The radio frequency signal received by the first port 11 may be transmitted to the second port 21, and the first port 11 and the second port 21 form the anti-interference path by using the bearing plate 30. The anti-interference path may be configured to cancel interference caused by coupling between the first radiation arm 12 and the second radiation arm 22. In other words, the radio frequency signal that is transmitted by the first port 11 and that is received by the second port 21 may be used to cancel the radio frequency signal that is radiated by the first radiation arm 12 and that is received by the second radiation arm 22, to cancel interference caused to the second antenna part 20 when the first antenna part 10 works.

Generally, if two antennas disposed in one device need to work independently, the two antennas need to meet an antenna isolation requirement. Antenna isolation represents a ratio of power of a signal transmitted by one antenna to power of a signal transmitted by another antenna. For example, if a distance between two antennas is 120 millimeter (mm), the two antennas can meet the antenna isolation requirement. In the antenna assembly provided in this embodiment of this application, the first antenna part 10 and the second antenna part 20 may be spatially coupled, and the anti-interference path is formed on the bearing plate 30, so that the first antenna part 10 and the second antenna part 20 can work independently. As shown in FIG. 1, the first radiation arm 12 is disposed on an end, close to the first port 11, of the bearing plate 30, the second radiation arm 22 is disposed on an end, close to the second port 21, of the bearing plate 30, and the first port 11 and the second port 21 may transmit a radio frequency signal by using the bearing plate 30. Therefore, both a first antenna assembly and a second antenna assembly are disposed on the bearing plate 30. This effectively reduces a size of the antenna.

It may be understood that the radiation arm in the antenna assembly is configured to radiate a radio frequency signal. When the first port 11 receives a radio frequency signal, the first radiation arm 12 may radiate the radio frequency signal. In an embodiment , if the first port 11 corresponds to two radiation arms, and each radiation arm is configured to radiate a corresponding radio frequency signal, the first antenna part 10 may radiate two radio frequency signals. For example, the first antenna part 10 may further include a third radiation arm 14, and the third radiation arm 14 is disposed on the second side of the bearing plate 30. The first radiation arm 12 may be configured to radiate a low-frequency radio frequency signal, and the third radiation arm 14 may be configured to radiate a high-frequency radio frequency signal. For example, the first port 11 is connected to a 2G radio frequency output end and a 5G radio frequency output end. In this case, the first radiation arm 12 corresponding to the first port 11 may radiate a radio frequency signal on a 2G frequency band, and the third radiation arm 14 may radiate a radio frequency signal on a 5G frequency band.

In another embodiment, if the second port 21 corresponds to two radiation arms, and each radiation arm is configured to radiate a corresponding radio frequency signal, the second antenna part 20 may radiate two radio frequency signals. For example, the second antenna part 20 may further include a fourth radiation arm 24, and the fourth radiation arm is disposed on the fourth side of the bearing plate 30. The second radiation arm 22 may be configured to radiate a low-frequency radio frequency signal, and the fourth radiation arm 24 may be configured to radiate a high-frequency radio frequency signal.

As shown in FIG. 2, the third radiation arm 14 is disposed on the second side of the bearing plate 30, and the third radiation arm 14 is disposed on an end away from the first radiation arm 12. The fourth radiation arm 24 is disposed on the fourth side of the bearing plate 30, and the fourth radiation arm 24 is disposed on an end close to the second radiation arm 22.

It may be understood that, when both the first port 11 and the second port 21 are corresponding to two radiation arms, a quantity of radiation arms in the antenna assembly increases, so that the antenna assembly can provide more links.

In a process in which the radiation arm radiates an electromagnetic wave, the radiation arm generates resonance, and a length of the radiation arm affects a frequency corresponding to a radio frequency signal radiated by the radiation arm. For example, the first port 11 may receive a first radio frequency signal and a second radio frequency signal. The first radio frequency signal corresponds to an electromagnetic wave having a first resonant frequency, and the second radio frequency signal corresponds to an electromagnetic wave having a second resonant frequency. In the first antenna part 10, a sum of a length of the first radiation arm 12 and a width of the first antenna gap is ¼ of a wavelength of the electromagnetic wave corresponding to the first resonant frequency, and the first radiation arm 12 is configured to receive or radiate a radio frequency signal having the first resonant frequency. A length of the third radiation arm 14 is ¼ of a wavelength of the electromagnetic wave corresponding to the second resonant frequency, and the third radiation arm 14 is configured to receive or radiate a radio frequency signal having the second resonant frequency. In the second antenna part 20, a sum of a length of the second radiation arm 22 and a width of the second antenna gap is ¼ of the wavelength of the electromagnetic wave corresponding to the first resonant frequency, and the second radiation arm 22 is configured to receive or radiate the radio frequency signal having the first resonant frequency. A length of the fourth radiation arm 24 is ¼ of the wavelength of the electromagnetic wave corresponding to the second resonant frequency, and the fourth radiation arm 24 is configured to receive or radiate the radio frequency signal having the second resonant frequency.

As shown in FIG. 2, L1 represents the length of the first radiation arm 12, and W1 represents the width of the first antenna gap. The sum of L1 and W1 is ¼ of the wavelength of the electromagnetic wave corresponding to the first resonant frequency. L3 represents the length of the third radiation arm 14, and L3 is ¼ of the wavelength of the electromagnetic wave corresponding to the second resonant frequency. L2 represents the length of the second radiation arm 22, and W2 represents the width of the second antenna gap. The sum of L2 and W2 is ¼ of the wavelength of the electromagnetic wave corresponding to the first resonant frequency. L4 represents the length of the fourth radiation arm 24, and L4 is ¼ of the wavelength of the electromagnetic wave corresponding to the second resonant frequency.

In some embodiments, different structures may be designed for the top of the first radiation arm 12. Such an adjustment to the structure of the top of the first radiation arm 12 is merely a change of a shape, without affecting performance of the first radiation arm 12. As shown in FIG. 2, an end, away from the second side, of the first radiation arm 12 is of an arc-shaped structure, and the top, away from the second side, of the first radiation arm 12 faces the first side. In some embodiments, the top, away from the fourth side, of the second radiation arm 22 is of an arc-shaped structure, and the top, away from the fourth side, of the second radiation arm 22 faces the third side.

It may be understood that the antenna assembly provided in this embodiment of this application may be referred to as a dual-frequency band and/or dual-feed antenna. In other words, the antenna assembly may receive radio frequency signals on two frequency bands, and the antenna assembly may feed out the radio frequency signals on the two frequency bands. Each antenna part in the antenna assembly includes one port and two radiation arms, so that the antenna part may receive two radio frequency signals, and radiate corresponding radio frequency signals using the two radiation arms. In other words, the antenna assembly may receive the radio frequency signals on the two frequency bands, and radiate the radio frequency signals on the two frequency bands.

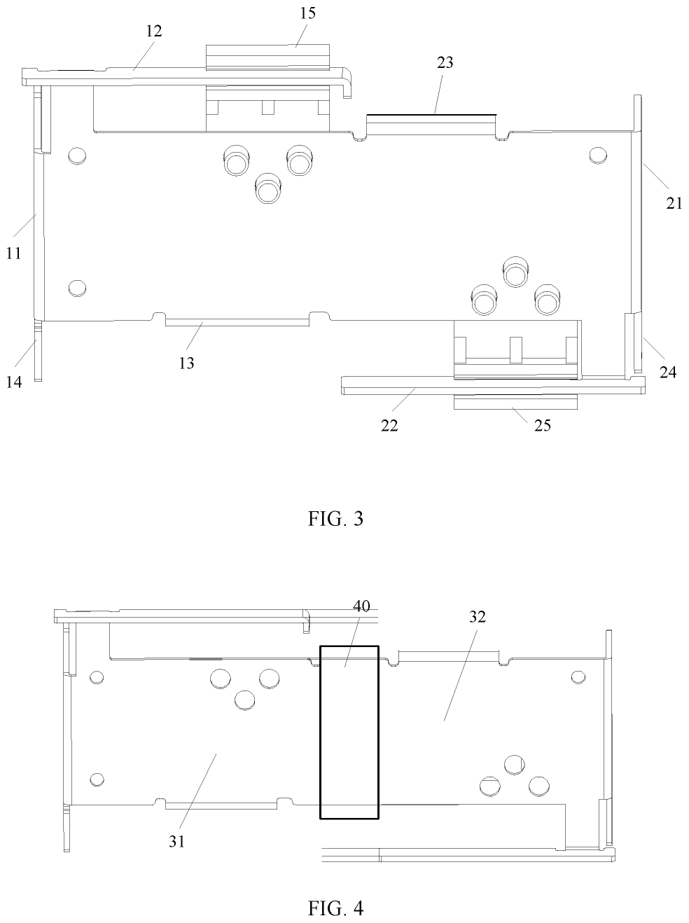

For example, the antenna assembly may further include a first support part 15 and a second support part 25. As shown in FIG. 3, the first support part 15 is disposed at a position of the first antenna gap, and is configured to support the first radiation arm and the bearing plate 30. The second support part 25 is disposed at a position of the second antenna gap, and is configured to support the second radiation arm and the bearing plate 30. A gap is disposed at one end of the first support part 15, and the first radiation arm 12 is disposed in the gap. The other end of the first support part 15 is of a snap-fit structure, and the snap-fit structure is configured to clamp the first bearing part 31, to prevent the first support part 15 from sliding on the first radiation arm 12. A structure of the second support part 25 is the same as that of the first support part 15, and details are not described again. Both the first support part 15 and the second support part 25 are made of a non-conductive material.

In the antenna assembly provided in this embodiment of this application, the first antenna part 10 and the second antenna part 20 divide the antenna assembly into two parts. In an implementation, the bearing plate 30 may be a complete metal plate or metal plating plate, and the first bearing part 31 and the second bearing part 32 each are a part of the bearing plate 30. In other words, the first antenna part 10 and the second antenna part 20 divide the antenna assembly into the first antenna part 10 and the second antenna part 20 based on a function and a correspondence with a port. In terms of structure, the antenna assembly includes the first port 11, the first radiation arm 12, the third radiation arm 14, and the first ground point 13 corresponding to the first port 11. The antenna assembly further includes the second port 21, the second radiation arm 22, the fourth radiation arm 24, and the second ground point 23 corresponding to the second port 21. The antenna assembly further includes the bearing plate 30.

The bearing plate 30 is a complete metal plate or metal plating plate, and the antenna assembly may be integrally formed. For example, a complete metal plate may be bent or cut to obtain the antenna assembly.

In another implementation, the bearing plate 30 may be formed by combining a plurality of metal parts or metal plating parts. As shown in FIG. 4, the bearing plate 30 includes the first bearing part 31, the second bearing part 32, and a connection part 40. The connection part 40 is configured to connect the first bearing part 31 and the second bearing part 32, to form the bearing plate 30. The first port 11, the first radiation arm 12, the third radiation arm 14, and the first ground point 13 corresponding to the first port 11 are disposed on the first bearing part 31, to form the first antenna part 10. The second port 21, the second radiation arm 22, the fourth radiation arm 24, and the second ground point 23 corresponding to the second port 21 are disposed on the second bearing plate 30 to form the second antenna part 20.

The antenna assembly provided in the embodiments of this application may be applied to a wireless access device, or the antenna assembly may be further applied to an electronic device. For example, the wireless access device in the embodiments of this application may be a router, a wireless controller, a wireless access point, a switch, or the like. In addition, the electronic device in the embodiments of this application may be a mobile phone, a tablet, a desktop computer, a laptop computer, a handheld computer, a notebook computer, a vehicle-mounted device, an ultra-mobile personal computer (UMPC), a netbook, a cellular phone, a personal digital assistant (PDA), an augmented reality (AR) device/a virtual reality (VR) device, or the like.

An embodiment of this application further provides a wireless access device. The wireless access device may include at least one antenna assembly, at least two radio frequency chipsets, and a mainboard. The at least two radio frequency chipsets and the at least one antenna assembly are all disposed on the mainboard. The antenna assembly fits the mainboard by using a patch technology, and the antenna assembly is located at a position close to an edge of the mainboard. The wireless access device further includes a matching circuit. An input end of the matching circuit is connected to an output end of the radio frequency chipset, and an output end of the matching circuit is connected to the first port 11 or the second port 21. The matching circuit is configured to adjust a radio frequency signal received by the first port 11 or the second port 21.

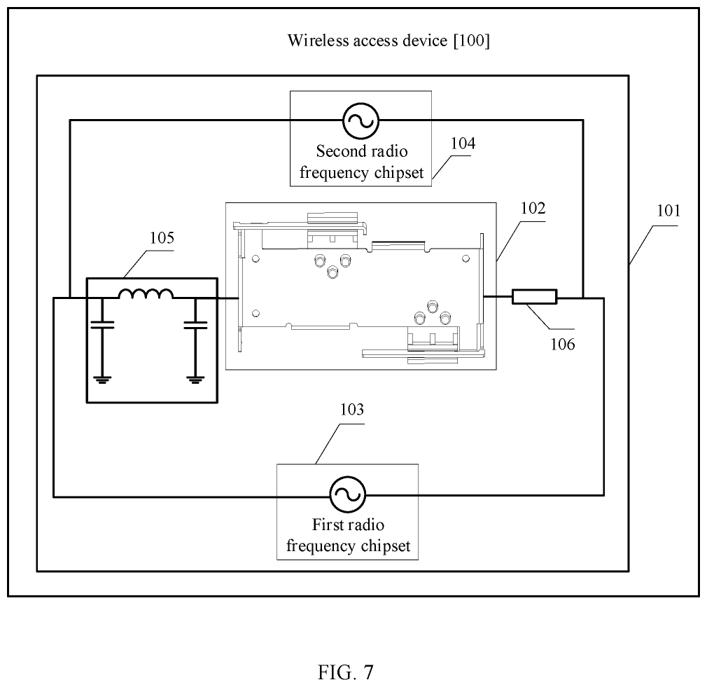

FIG. 7 is a diagram of a hardware structure of a wireless access device according to an embodiment of this application. As shown in FIG. 7, a wireless access device 100 includes a mainboard 101, an antenna assembly 102, a first radio frequency chipset 103, a second radio frequency chipset 104, a first matching circuit 105, and a second matching circuit 106. An output end of the first radio frequency chipset 103 is connected to both an input end of the first matching circuit 105 and an input end of the second matching circuit 106. An output end of the second radio frequency chipset 104 is connected to both the input end of the first matching circuit 105 and the input end of the second matching circuit 106. An output end of the first matching circuit 105 is connected to a first port 11, and an output end of the second matching circuit 106 is connected to a second port 22. A feed ground end on the mainboard 101 is connected to a first ground point 13 and a second ground point 23 (which are not shown in the figure) in the antenna assembly 102.

In some embodiments, matching circuits (for example, the first matching circuit 105 and the second matching circuit 106) are further connected between an input end of an antenna assembly and an output end of a radio frequency chipset, and the matching circuit is set to a it-type matching circuit. Alternatively, a resistive element may be used as a matching circuit. A specific form of the matching circuit is not limited herein. The matching circuit may adjust matched impedance of a first port or a second port, and does not affect isolation between the first port and the second port. A radio frequency output end of the radio frequency chipset is connected to the first port or the second port. If impedance of the first port does not match impedance of the output end of the radio frequency chipset, radiation of a radio frequency signal by the first port is affected, and consequently, the isolation between the first port and the second port is affected. The matching circuit may adjust the matched impedance of the first port or the second port, so that the impedance of the first port is the same as the impedance of the output end of the radio frequency chipset, to ensure that the first port or the second port works normally and the isolation between the first port and the second port is not affected.

It may be understood that, this embodiment of this application uses an example in which the first matching circuit 105 is a π-type matching circuit and the second matching circuit 106 is a resistive element.

The antenna assembly 102 provided in this embodiment of this application may receive two radio frequency signals, and radiate the radio frequency signals by using two radiation arms. The first antenna part 10 and the second antenna part 20 in the antenna assembly 102 may work independently, so that the antenna assembly 103 in the wireless access device 100 can provide more links. This helps miniaturize the wireless access device 100. The antenna assembly 102 provided in this embodiment of this application is used in the wireless access device 100, so that the wireless access device 100 can provide more links, and a problem that a size of the wireless access device 100 is relatively large due to an increase in a quantity of antennas can also be resolved.

In some embodiments, the radio frequency chipsets are separately disposed on two sides of the mainboard 101, so that space on the two sides of the mainboard 101 can be effectively utilized. For example, if the wireless access device includes a 2G radio frequency chipset (the first radio frequency chipset 103) and a 5G radio frequency chipset (the second radio frequency chipset 104), the 2G radio frequency chipset is disposed on a first surface of the mainboard 101, and the 5G radio frequency chipset is disposed on a second surface of the mainboard 101.

It is assumed that the wireless access device 100 includes a first antenna assembly and a second antenna assembly. To ensure isolation between the first antenna assembly and the second antenna assembly, a value of a distance between the first antenna assembly and the second antenna assembly is greater than a preset distance value. For example, the value of the distance between the first antenna assembly and the second antenna assembly is 120 mm.

It may be understood that the wireless access device 100 further includes hardware such as a processor and a memory. The memory and the processor are connected through a bus. The bus may include any quantity of internet buses and bridges, and the bus connects various circuits of one or more processors and memories. The bus may further connect various circuits such as a peripheral device, a voltage stabilizer, and a power management circuit. These are common in the art, and therefore are not further described in this specification. A bus interface provides an interface between the bus and a phased array antenna, and data processed by the processor is transmitted to the memory through the interface. The processor is responsible for managing the bus and is responsible for general processing, and may further provide various functions, including timing, peripheral interface, voltage regulation, power management, and other control functions. The memory may be further configured to store data used when the processor performs an operation.

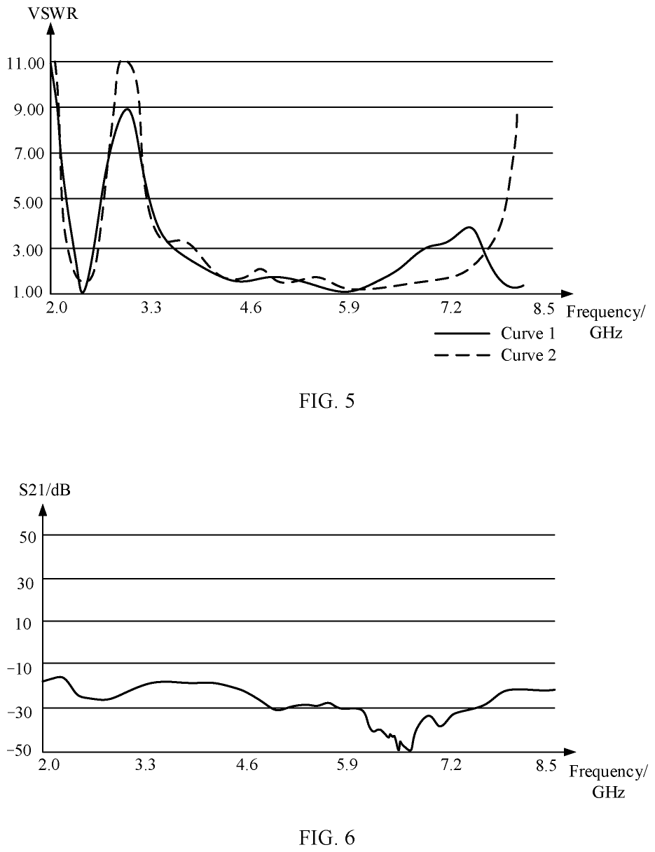

The wireless access device 100 provided in the foregoing implementation can provide a plurality of links. This reduces a quantity of antennas disposed in the wireless access device, and helps miniaturize the wireless access device. After the antenna assembly is mounted in the wireless access device 100, a quantity of links in a wireless access system can be increased, and isolation between the first antenna part and the second antenna part in the antenna assembly in the wireless access device 100 can also meet a requirement. FIG. 5 shows standing wave ratios of a first port and a second port in an antenna assembly mounted in a wireless access device. A curve 1 represents the standing wave ratio of the first port, and a curve 2 represents the standing wave ratio of the second port. In other words, the curve 1 represents a voltage standing wave ratio of the first port on a first frequency (2.4 GHz to 2.5 GHz) and a second frequency (5.15 GHz to 5.85 GHz). The curve 2 represents a voltage standing wave ratio of the second port on the first frequency (2.4 GHz to 2.5 GHz) and the second frequency (5.15 GHz to 5.85 GHz). The voltage standing wave ratios shown in FIG. 5 represent an impedance matching degree of the first port and the second port.

FIG. 6 shows isolation between a first port and a second port in an antenna assembly. As shown in FIG. 6, a second antenna part radiates a radio frequency signal, and a first antenna part may receive the radio frequency signal radiated by the second antenna part. On a first frequency band (2.4 GHz to 2.5 GHz) and a second frequency band (5.15 GHz to 5.85 GHz) of the antenna assembly, the isolation of the antenna assembly is relatively good.

The foregoing descriptions are merely implementations of this application, and are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. An antenna assembly, comprising:
a first port;
a first radiation arm and a first ground point corresponding to the first port;
a second port;
a second radiation arm and a second ground point corresponding to the second port; and
a bearing plate;
the first port, the first radiation arm, the first ground point, and a first bearing part of the bearing plate forming a first antenna part, and
the second port, the second radiation arm, the second ground point, and a second bearing part of the bearing plate forming a second antenna part;
the first radiation arm is configured to radiate a radio frequency signal received by the first port and transmit a received radio frequency signal to the first port;
the second radiation arm is configured to radiate a radio frequency signal received by the second port and transmit a received radio frequency signal to the second port; and
an anti-interference path passing through the bearing plate between the first port and the second port, the anti-interference path configured to cancel interference caused by coupling between the first radiation arm and the second radiation arm.

2. The antenna assembly according to claim 1, wherein:
the first radiation arm is disposed on a first side of the bearing plate, a part of the first radiation arm is connected to the bearing plate, a first antenna gap exists between the first radiation arm and the bearing plate, the first port is disposed on a second side of the bearing plate, and the first ground point is disposed on a third side of the bearing plate; and
the second radiation arm is disposed on the third side of the bearing plate, a part of the second radiation arm is connected to the bearing plate, a second antenna gap exists between the second radiation arm and the bearing plate, the second port is disposed at a position on a fourth side of the bearing plate opposite to the first port, and the second ground point is disposed on the first side of the bearing plate;
the first side is opposite to the third side, and the second side is opposite to the fourth side.

3. The antenna assembly according to claim 1, wherein the first antenna part further comprises a third radiation arm corresponding to the first port, the third radiation arm being disposed on the second side of the bearing plate;
the second antenna part further comprises a fourth radiation arm corresponding to the second port, the fourth radiation arm being disposed on the fourth side of the bearing plate; and
wherein the first radiation arm and the second radiation arm are configured to radiate a low-frequency radio frequency signal, and the third radiation arm and the fourth radiation arm are configured to radiate a high-frequency radio frequency signal.

4. The antenna assembly according to claim 1, wherein the first bearing part and the second bearing part are integrally formed to form the bearing plate, or the first bearing part and the second bearing part are connected by a connection part to form the bearing plate; and
the first port, the first radiation arm, the third radiation arm, and the first ground point are disposed on the first bearing part, and the second port, the second radiation arm, the fourth radiation arm, and the second ground point are disposed on the second bearing part.

5. The antenna assembly according to claim 1, wherein:
the first radiation arm is disposed on an end of the bearing plate, close to the first port, and the third radiation arm is disposed on an end of the bearing plate, away from the first radiation arm; and
the second radiation arm is disposed on an end of the bearing plate, close to the second port, and the fourth radiation arm is disposed on an end of the bearing plate, close to the second radiation arm.

6. The antenna assembly according to claim 2, wherein a sum of a length of the first radiation arm and a width of the first antenna gap is ¼ of a wavelength of an electromagnetic wave corresponding to a first resonant frequency, and the first radiation arm is configured to receive or radiate a radio frequency signal having the first resonant frequency; and
a length of the third radiation arm is ¼ of a wavelength of an electromagnetic wave corresponding to a second resonant frequency, and the third radiation arm is configured to receive or radiate a radio frequency signal having the second resonant frequency.

7. The antenna assembly according to claim 2, wherein a sum of a length of the second radiation arm and a width of the second antenna gap is ¼ of the wavelength of the electromagnetic wave corresponding to the first resonant frequency, and the second radiation arm is configured to receive or radiate the radio frequency signal having the first resonant frequency; and
a length of the fourth radiation arm is ¼ of the wavelength of the electromagnetic wave corresponding to the second resonant frequency, and the fourth radiation arm is configured to receive or radiate the radio frequency signal having the second resonant frequency.

8. The antenna assembly according to claim 1, wherein a top of the first radiation arm, away from the second side, is of an arc-shaped structure, and the top of the first radiation arm, away from the second side, faces the first side.

9. The antenna assembly according to claim 1, wherein a top of the second radiation arm, away from the fourth side, is of an arc-shaped structure, and the top of the second radiation arm, away from the fourth side, faces the third side.

10. The antenna assembly according to claim 2, wherein the bearing plate is a conductor part, and the conductor part comprises a metal part or a metal plating part.

11. A wireless access device, comprising:
a mainboard;
an antenna assembly, comprising:
a first port;
a first radiation arm and a first ground point corresponding to the first port;
a second port;
a second radiation arm and a second ground point corresponding to the second port; and
a bearing plate;
the first port, the first radiation arm, the first ground point, and a first bearing part of the bearing plate forming a first antenna part;
the second port, the second radiation arm, the second ground point, and a second bearing part of the bearing plate forming a second antenna part;
the first radiation arm configured to radiate a radio frequency signal received by the first port and transmit a received radio frequency signal to the first port;
the second radiation arm configured to radiate a radio frequency signal received by the second port and transmit a received radio frequency signal to the second port; and
an anti-interference path passing through the bearing plate between the first port and the second port, the anti-interference path configured to cancel interference caused by coupling between the first radiation arm and the second radiation arm;
at least two radio frequency chipsets, a radio frequency output end of each radio frequency chipset is connected to the first port and to the second port of the antenna assembly, and a feed ground end on the mainboard is connected to the first ground point and the second ground point of the antenna assembly.

12. The wireless access device according to claim 11, wherein the antenna assembly fits the mainboard, and the antenna assembly is located at a position close to an edge of the mainboard.

13. The wireless access device according to claim 11, wherein the radio frequency chipset comprises a first radio frequency chipset and a second radio frequency chipset, the first radio frequency chipset is disposed on a first surface of the mainboard, and the second radio frequency chipset is disposed on a second surface of the mainboard.

14. The wireless access device according to claim 11, wherein the wireless access device further comprises a matching circuit, wherein:
an input end of the matching circuit is connected to the output end of the radio frequency chipset, and an output end of the matching circuit is connected to the first port or the second port; and
the matching circuit is configured to adjust a first port impedance of the first port or a second port impedance of the second port, so that an output end impedance of the output end of the radio frequency chipset is equal to the first port impedance or the second port impedance .

15. The wireless access device according to claim 11, wherein the wireless access device comprises a first antenna assembly and a second antenna assembly, and a distance between the first antenna assembly and the second antenna assembly is greater than a preset distance value.
